(19) United States
(12) Patent Application Publication
(10) Pub. No.: US 2026/0266536 A1
(43) Pub. Date: Sep. 10, 2026

(54) VACUUM INSULATION PANEL

(71) Applicant: SAMSUNG ELECTRONICS CO., LTD., Suwon-si (KR)

(72) Inventors: Sunghwan HONG, Suwon-si (KR); Jungsoo LIM, Suwon-si (KR); Yeonkyoung Jung, Suwon-si (KR)

(73) Assignee: SAMSUNG ELECTRONICS CO., LTD., Suwon-si (KR)

(21) Appl. No.: 19/659,544

(22) Filed: Apr. 27, 2026

Related U.S. Application Data
(63) Continuation of application No. PCT/KR2024/012689, filed on Aug. 26, 2024.

(30) Foreign Application Priority Data
Nov. 9, 2023 (KR) 10-2023-0154610

(51) Int. Cl. F25D 23/08; B32B 9/04; B32B 27/32; B32B 27/34

(52) U.S. Cl. CPC F25D 23/08; B32B 9/045; B32B 27/32; B32B 27/34; B32B 2250/05; B32B 2262/101; B32B 2307/304; B32B 2307/54; B32B 2307/546; B32B 2307/7376; B32B 2607/00; F25D 2201/14

(57) ABSTRACT

A vacuum insulation panel includes: an outer shell material defining a receiving space therein; and a core material in the receiving space; wherein the core material includes: a first core material layer comprising a support extending in a longitudinal direction of the outer shell material, the support comprising a porous material; and a second core material layer in contact with the first core material layer, extending in the longitudinal direction of the outer shell material, the second core material layer comprising a plurality of laminated materials arranged parallel to a direction in which the outer shell material extends.

### CROSS-REFERENCE TO RELATED APPLICATIONS

This application is a Continuation Application of International Application PCT/KR2024/012689 filed on Aug. 26, 2024, which claims priority to Korean Patent Application No. 10-2023-0154610, filed on Nov. 9, 2023, in the Korean Ministry of Intellectual Property, the disclosures of which are incorporated by reference herein in their entireties.

### BACKGROUND

### 1. Field

The disclosure relates to a vacuum insulation panel.

### 2. Description of Related Art

Insulation is used to keep warm or block heat. For example, insulation may be used in a refrigerator to insulate the interior and exterior of a storage compartment of the refrigerator.

Typically, polyurethane foam may be utilized as an insulation in refrigerators. Polyurethane foam may need to be somewhat thicker to provide adequate insulation for refrigerator applications, which may reduce the storage space inside the refrigerator.

Vacuum insulation panels have a lower thermal conductivity than polyurethane foam, so they may be fabricated thinner than polyurethane foam while still providing the desired insulation effect for refrigerator applications. Thus, attempts are being made to use vacuum insulation panels in refrigerators.

A vacuum insulation panel is an insulation material in which the exterior of a core material is packed with an outer shell material including a plurality of outer shell layers, and the interior is vacuumed. The vacuum insulation panel has the advantage of excellent thermal insulation performance, but it may lack rigidity because the core material is mostly in a vacuum state and the outer shell material has a thin thickness.

### SUMMARY

Provided is a vacuum insulation panel including a structure which may have improved rigidity.

Further, provided is a vacuum insulation panel including a structure that may improve insulating life.

Further, provided is a vacuum insulation panel that may be utilized in a refrigerator to improve the insulation performance of the refrigerator.

Further, provided is a vacuum insulation panel that may be utilized in a refrigerator to increase the storage space of the refrigerator.

Technical tasks to be achieved in this document are not limited to the technical tasks mentioned above, and other technical tasks not mentioned will be clearly understood by those skilled in the art from the description below.

According to an aspect of the disclosure, a vacuum insulation panel includes: an outer shell material defining a receiving space therein; and a core material in the receiving space; wherein the core material includes: a first core material layer comprising a support extending in a longitudinal direction of the outer shell material, the support comprising a porous material; and a second core material layer in contact with the first core material layer, extending in the longitudinal direction of the outer shell material, the second core material layer comprising a plurality of laminated materials arranged parallel to a direction in which the outer shell material extends.

Each of the plurality of laminated materials includes a vermiculite sheet exfoliated from vermiculite.

The first core material layer may include a plurality of first core material layers, the second core material layer may include a plurality of second core material layers, and the plurality of first core material layers and the plurality of second core material layers may be alternately laminated.

A flexural modulus of the vacuum insulation panel may be at least 300 MPa.

The support may include glass fibers constituting glass wool, and a volume fraction of the support relative to the receiving space may be at least 10 vol %.

A volume fraction of the plurality of laminated materials relative to the receiving space may be at least 9.2 vol %.

A thickness of the vacuum insulation panel may be in a range of 9.9 mm to 16.5 mm, inclusive.

The second core material layer may include a binder configured to bond the plurality of laminated materials to each other, and the binder may include any one of polyvinylidene fluoride (PVDF) or polytetrafluoroethylene (PTFE).

The outer shell material may include: a first outer shell layer in contact with the core material; and a second outer shell layer spaced apart from the first outer shell layer and forming an outer surface of the vacuum insulation panel.

The first outer shell layer may include linear low density polyethylene (LLDPE), and the second outer shell layer may include nylon.

The outer shell material may not include a metal or a metal oxide.

The receiving space may be in a vacuum state.

According to an aspect of the disclosure, a vacuum insulation panel includes an outer shell material defining a receiving space therein and including a plurality of outer shell layers, and a core material in the receiving space. The core material may include a first core material layer including a support extending in a longitudinal direction of the outer shell material. The support may include glass fibers constituting glass wool. The core material layer may include a second core material layer in contact with the first core material layer, extending in the longitudinal direction of the outer shell material. The second core material layer may include a plurality of laminated materials arranged parallel to a direction in which the outer shell material extends. Each of the plurality of laminated materials may include a vermiculite sheet exfoliated from vermiculite.

The first core material layer may be in a vacuum state, and the second core material layer may not include an air layer, such that the receiving space may be maintained a vacuum.

The first core material layer may include a plurality of first core material layers. The second core material layer may include a plurality of second core material layers. The plurality of first core material layers and the plurality of second core material layers are alternately laminated.

A volume fraction of the support relative to the receiving space may be at least 10 vol % or more.

A volume fraction of the plurality of laminated materials relative to the receiving space may be at least 9.2 vol %.

A flexural modulus of the vacuum insulation panel may be at least 300 MPa.

The second core material layer may include a binder configured to bond each of the plurality of laminated materials to each other. The binder may include any one of polyvinylidene fluoride (PVDF) or polytetrafluoroethylene (PTFE).

The outer shell material may include a first outer shell layer in contact with the core material, the first outer shell layer may include linear low density polyethylene (LLDPE). The second outer shell layer may be spaced apart from the first outer shell layer and may form an outer surface of the vacuum insulation panel. The second outer shell layer may include a nylon material.

According to an aspect of the disclosure, a vacuum insulation panel includes an outer shell material, including a plurality of outer shells, defining a receiving space provided in a vacuum state, and a core material in the receiving space. The core material may include a first core material layer including a support extending in a longitudinal direction of the outer shell material. A volume fraction of the support relative to the receiving space is at least 10 vol %. The core material may include a second core material layer in contact with the first core material layer, and extending in the longitudinal direction of the outer shell material. The second core material layer may include a plurality of laminated materials arranged parallel to a direction in which the outer shell material extends. Each of the plurality of laminated materials may include a vermiculite sheet exfoliated from vermiculite. A volume fraction of the plurality of laminated materials relative to the receiving space is at least 9.2 vol %. Each of the plurality of laminated materials may include a vermiculite sheet exfoliated from vermiculite, and a flexural modulus of the vacuum insulation panel is at least 300 MPa.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view illustrating a vacuum insulation panel according to one or more embodiments;

FIG. 2 is a cross-sectional view illustrating the vacuum insulation panel of FIG. 1 cut along line a-a′;

FIG. 3 is an enlarged view illustrating portion A1 of FIG. 2;

FIG. 4 is an enlarged view illustrating portion A2 of FIG. 2;

FIG. 5 is a view illustrating a process in which a plurality of materials are arranged and laminated in a vacuum insulation panel according to one or more embodiments;

FIG. 6 is a view illustrating a state where a second core material layer is stacked on a first core material layer to form a core material in a vacuum insulation panel according to one or more embodiments;

FIG. 7 is a schematic view illustrating a state where a vacuum insulation panel according to one or more embodiments is deformed by an external force; and

FIG. 8 is a view of a vacuum insulation panel according to one or more embodiments, in which heat is transmitted through the vacuum insulation panel in the form of conduction and radiation.

### DETAILED DESCRIPTION

The embodiments described herein are non-limiting example embodiments, and thus, the disclosure is not limited thereto and may be realized in various other forms. Each of the embodiments provided herein is not excluded from being associated with one or more features of another example or another embodiment also provided herein or not provided herein but consistent with the disclosure.

In connection with the description of the drawings, similar reference numerals may be used for similar or related components.

Also, the terms used herein are used to describe the embodiments and are not intended to limit and/or restrict the disclosure. The singular forms “a”, “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Meanwhile, terms used in the following description such as “front”, “rear”, “left”, and “right”, “upper”, “lower”, and the like, are defined based on the drawings, and the shape and position of each element are not limited by these terms.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element, or additional subsequent element(s).

It will also be understood that when an element is referred to as being “on” another element, it may be directly on the other element or intervening elements may also be present.

In referring to a direction of rotation, a clockwise direction may be expressed as a first direction, and a counterclockwise direction, which is an opposite of the first direction, may be expressed as a second direction. Such expressions may be commonly used in describing specific details for implementing the disclosure, but the direction of rotation of the configurations of the present disclosure are not limited by such terms.

Hereinafter, various embodiments of a vacuum insulation panel according to the present disclosure will be described in detail with reference to the accompanying drawings.

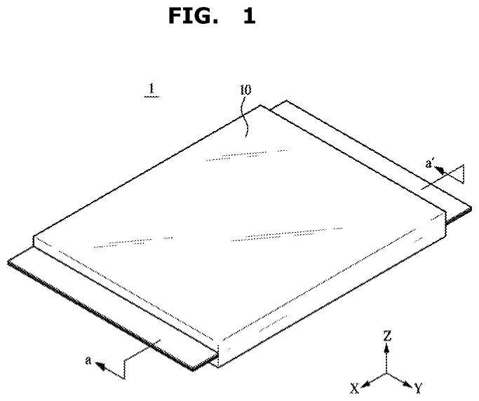

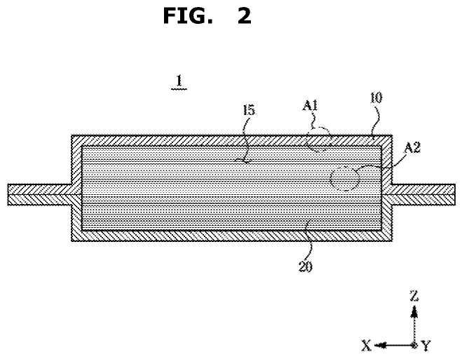

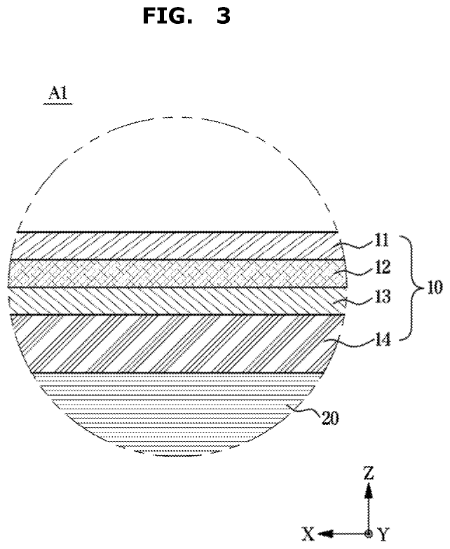

FIG. 1 is a schematic view illustrating a vacuum insulation panel according to one or more embodiments. FIG. 2 is a cross-sectional view illustrating the vacuum insulation panel of FIG. 1 cut along line a-a′. FIG. 3 is an enlarged view illustrating portion A1 of FIG. 2.

Referring to FIGS. 1 to 3, a vacuum insulation panel 1 may include an outer shell material 10 and a core material 20, which is received in a receiving space 15 formed by the outer shell material 10. The outer shell material 10 may be disposed on an outer side of the core material 20 to receive the core material 20. The receiving space 15 of the outer shell material 10 may be provided to be vacuumed inside, and the core material 20 may be received in the vacuumed internal space 15.

In an example, the core material 20 may include glass wool, fumed silica, or the like. The core material 20 may include a porous material, and void spaces 212 of the porous material may be maintained in a vacuum state, thereby allowing the vacuum outer shell material 10 to perform an insulating function. In the following, the core material 20 will be shown and described as including glass wool, but the core material 20 is not so limited.

To maintain the internal space 15 in a vacuum state, the outer shell material 10 may be configured to prevent the ingress of gases, such as air or gas, and moisture. For example, the outer shell material 10 may include a moisture and gas barrier film. The core material 20 may be protected by the outer shell material 10 to maintain its insulating life.

The outer shell material 10 may include a plurality of outer shell layers 11, 12, 13 and 14. The plurality of outer shell layers 11, 12, 13 and 14 may be stacked in an outward direction to surround the core material 20. For example, the plurality of outer shell layers 11, 12, 13 and 14 may be nested in an outward direction to surround the core material 20. The plurality of outer shell layers 11, 12, 13 and 14 may be formed of different materials. In addition, the plurality of outer shell layers 11, 12, 13 and 14 may be formed to have different thicknesses.

The outer shell material 10 may include the first outer shell layer 14. The first outer shell layer 14 may be disposed to enclose an outer surface of the core material 20 and configured to be in contact with the core material 20.

For example, the first outer shell layer 14 may include a linear low density polyethylene (LLDPE) material. The LLDPE may stably support the core material 20 by contacting the outer surface of the core material 20.

The outer shell material 10 may include the second outer shell layer 11 disposed spaced apart from the first outer shell layer 14 in the outward direction. The second outer shell layer 11 may be disposed on an outermost portion of the outer shell material 10.

In an example, the second outer shell layer 11 may include a polyamide (PA) based fiber material. In an example, the PA may be made of Nylon to prevent external water vapor from permeating the outer shell layer.

The outer shell material 10 may include the third outer shell layer 12 disposed between the first outer shell layer 14 and the second outer shell layer 11.

In an example, the third outer shell layer 12 may be disposed to be in contact with an inner surface of the second outer shell layer 11. In an example, the third outer shell layer 12 may include a polyethylene terephthalate (PET) material.

The outer shell material 10 may include the fourth outer shell layer 13 disposed between the first outer shell layer 14 and the second outer shell layer 11.

In an example, the fourth outer shell layer 13 may be disposed to be in contact with an inner surface of the third outer shell layer 12. In an example, the fourth outer shell layer 13 may be disposed to be in contact with an outer surface of the first outer shell layer 14.

In an example, the fourth outer shell layer 13 may include an ethylene vinyl alcohol (EVOH) material. The EVOH may be disposed on the outer side of the core material 20 and may perform a function of preventing oxygen, carbon dioxide, water vapor, and the like from permeating into the core material 20.

In an example, any one of the outer shell layers 11, 12, 13 and 14 described above may include polyvinylidene fluoride (PVDF). In an example, all of the outer shell layers 11, 12, 13 and 14 described above may include PVDF.

As will be described later, the outer shell material 10 described above may not include a metal or metal oxide material. In an example, the outer shell material 10 may not include aluminum (AL), aluminum oxide (ALO_{X}), or the like. Since the outer shell material 10 does not include a metal or metal oxide material, heat transfer by thermal bridging phenomena occurring in the outer shell material 10 may be prevented. Therefore, the thermal insulation performance of the vacuum insulation panel 1 may be further improved.

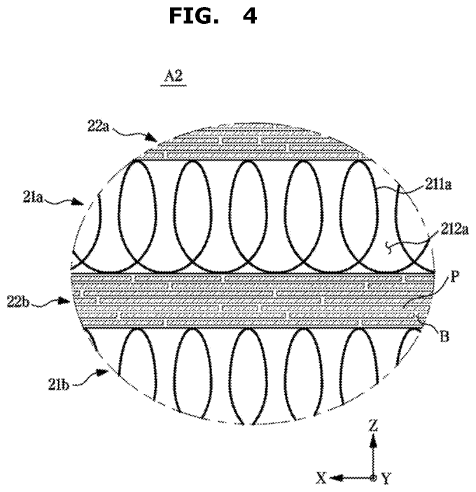

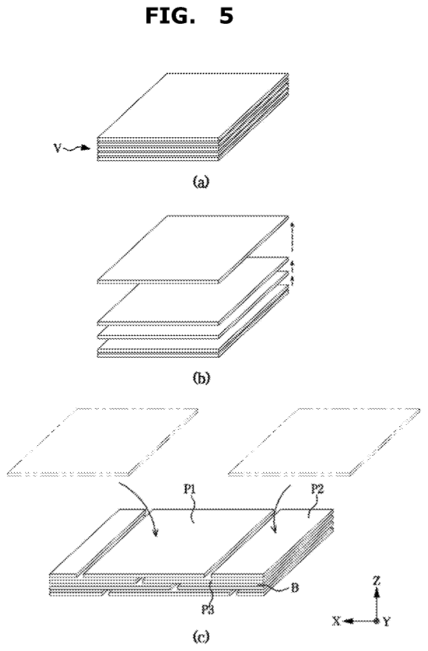

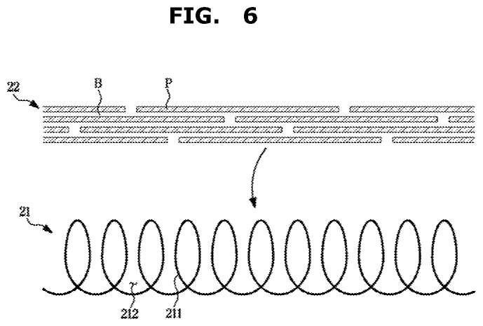

FIG. 4 is an enlarged view illustrating portion A2 of FIG. 2. FIG. 5 is a view illustrating a process in which a plurality of materials P are arranged and laminated in a vacuum insulation panel according to one or more embodiments. FIG. 6 is a view illustrating a state where a second core material layer is laminated to a first core material layer to form a core material in the vacuum insulation panel according to one or more embodiments.

Referring to FIGS. 4 to 6, the core material 20 may be formed to extend in a longitudinal direction of the outer shell material 10. In an example, the longitudinal direction of the outer shell material 10 may be a horizontal direction (+−X direction).

The core material 20 may include a first core material layer 21 forming a portion of the core material 20. The first core material layer 21 may be made of a porous material. In an example, the first core material layer 21 may include a glass wool material.

The first core material layer 21 may include a support 211 forming the first core material layer 21. In an example, when the first core material layer 21 is glass wool, the support 211 may include glass fibers forming the glass wool.

The support 211 may be formed to extend in the longitudinal direction (+−X direction) of the outer shell material 10. The support 211 may provide rigidity to the core material 20 to allow the core material 20 to maintain its shape, and may serve to support the vacuum insulation panel 1.

Furthermore, the first core material layer 21 may be include a porous material, and the receiving space 15 in which the core material 20 is received may be provided in a vacuum, the void spaces 212 of the first core material layer 21 may be in a vacuum state. Therefore, heat transfer through the core material 20 may be prevented.

The core material 20 may include a second core material layer 22 forming the remaining portion of the core material 20. In an example, the second core material layer 22 may be in contact with the first core material layer 21 and extend in the longitudinal direction (+−X direction) of the outer shell material 10.

The second core material layer 22 may perform functions of further increasing the rigidity of the vacuum insulation panel 1 and reducing the amount of heat transfer. Further details thereof will be described later.

The second core material layer 22 may include a plurality of materials P arranged in a direction parallel to the direction in which the outer shell material 10 extends (+−X direction) and laminated in the outward direction (+−Z direction). The plurality of materials may be plate-like materials. It is understood, that the term “plate-like” refers to a structure characterized by having a thickness that is small compared to its length and width.

In an example, the plurality of materials P may include vermiculite sheets P formed by exfoliation from vermiculite V. In the following, the plurality of materials P will be described assuming that they are vermiculite sheets P, but are not so limited.

As discussed above, the vermiculite sheets P, which are the plurality of materials P, may be formed by exfoliation from a raw material, vermiculite V. The vermiculite V, machined into Expanded Vermiculite, may be then removed of impurities utilizing a density gradient separation method.

Thereafter, the vermiculite V may be mixed with NaCl and water at a mass ratio of 1:1 and a concentration of 50 mg/ml, and subjected to a ball milling process at 400-1000 rpm to exfoliate a plurality of materials P. Furthermore, ultrasonic and centrifugation processes may be performed to more effectively exfoliate the plurality of materials P.

The exfoliated vermiculite sheets P may be mixed with water or ethanol, and a binder B for bonding the materials together may be mixed at a mass percentage of 1 wt % based on the mass of the vermiculite. Thus, the binder B may be disposed between the plurality of materials P to form the second core material layer 22 together.

In an example, the binder B may include PUA, PVDF, PTFE, or the like, and may include a curable resin, but such binders are by way of examples only, and binders B including a variety of materials may be applied.

The mixed solution of the vermiculite sheet P and the binder B may then be applied onto the support 211 forming the first core material layer 21. FIG. 6 illustrates the plurality of vermiculite sheets P being randomly arranged and laminated, with the mixed solution being applied to the support 211.

For ease of description, the plurality of vermiculite sheets P are shown as being regularly arranged and laminated in a side-by-side orientation, but the plurality of vermiculite sheets P may be randomly arranged in horizontal and vertical directions.

The applied mixed solution may then be dried at a temperature of 25-50° C. to form the second core material layer 22 including a plurality of vermiculite sheets P. Thus, the second core material layer 22 may be formed by laminating on the first core material layer 21 in contact with the first core material layer 21.

It should be appreciated that the above-described manner in which the second core material layer 22 is formed is merely an example, and that the second core material layer 22 may be formed in various ways other than the method described above, such as in a manner in which the second core material layer 22 is formed separately and then bonded to the first core material layer 21.

As shown in FIG. 4, the first core material layer 21 may include a plurality of first core material layers 21a and 21b, and the second core material layer 22 may include a plurality of second core material layers 22a and 22b. The plurality of first core material layers 21 and the plurality of second core material layers 22 may be arranged alternately with each other in the outward direction by one layer each. In an example, on top of the second core material layer 22b stacked on the first core material layer 21b, another first core material layer 21a including a support 211a may be stacked. Then, another second core material layer 22a may be stacked on top of yet another first core material layer 21a. As the first core material layers 21a and 21b and the second core material layers 22a and 22b are alternately stacked, the core material 20 may be formed with a proper distribution of the support 211, the materials P, and the void spaces 212.

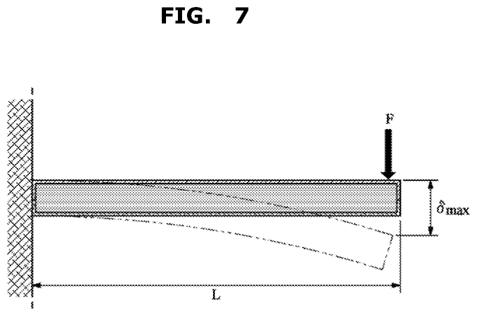

FIG. 7 is a schematic view illustrating a state where a vacuum insulation panel according to one or more embodiments is deformed by an external force.

The vacuum insulation panel 1 needs to be designed to have rigidity suitable for its intended of use. This is because when the vacuum insulation panel 1 is not rigid enough, the amount of deformation may increase in an environment where external force is applied, causing damage to the panel, and the insulation performance may decrease accordingly.

When determining the rigidity of the vacuum insulation panel 1, the flexural modulus (E_{f}) may be the criterion. The flexural modulus (E_{f}) may refer to the ratio of stress applied to deformation that occurs in a bending test, and may be a criterion for measuring the rigidity of a material.

Hereinafter, it will be described how the flexural modulus (E_{f}) of the vacuum insulation panel 1 may be adjusted to reach a target value, in terms of the volume ratio of the support 211 and the materials P included in the core material 20.

In an example, it may be assumed that the target flexural modulus (E_{f}) of the vacuum insulation panel 1 is 300 MPa.

In the case of the outer shell material 10 of the vacuum insulation panel 1, which is only tens of μm in thickness, its contribution to the flexural modulus of the entire vacuum insulation panel 1 may be very small compared to the core material 20. Therefore, in the following calculations, only the flexural modulus (E_{f}) of the core material 20 may be considered.

In an example, it may be that the support 211 is a glass fiber forming glass wool and the plurality of materials P are vermiculite sheets P exfoliated from vermiculite V.

The core material 20 of the vacuum insulation panel 1 may comprise glass wool of the first core material layer 21, and vermiculite sheets P of the second core material layer 22. Glass wool, which is a porous material, may include glass fibers 211 and the void spaces 212 provided in a vacuum state.

Thus, the flexural modulus (E_{f}) of 300 MPa targeted by the vacuum insulation panel 1 may be expressed by the following Rules of Mixture equation.

300=E_{f,G}*V_{G}(%)+E_{f,s}*Vs(%)+E_{f,v}*Vv(%)

Wherein, E_{f,G} may denote the flexural modulus of the support 211 (glass fibers), and V_{G} may denote the ratio (vol %) of the volume of the support 211 to the total volume of the receiving space 15. E_{f,s} may be the flexural modulus of the void spaces 212 provided in a vacuum state, and thus a value of 0 may be substituted therefor. E_{f,v} may denote the flexural modulus of the materials P (vermiculite sheets), and Vv may denote the ratio (vol %) of the volume of the vermiculite sheets P to the volume of the receiving space 15. By substituting 0 for E_{f,s}, the Rules of Mixture equation may be simplified as follows.

300=E_{f,G}*V_{G}(%)+E_{f,v}*Vv(%)

In the following, V_{G}(%) and the corresponding E_{f,G} may be calculated.

For example, unlike the above, in the case of a vacuum insulation panel in which the core material is formed only of glass wool, the density of the core material, which includes glass fibers constituting the glass wool and the void space provided in a vacuum state, may be measured to be approximately 280 kg/m³. In this case, considering that the known density of the glass material forming the glass fibers is approximately 2800 kg/m³ and the density of the void space in a vacuum state is 0, it may be calculated that the glass fibers included in the vacuum insulation panel may occupy approximately 10% of the volume of the core material receiving space. Such a value may be equally applicable to the present disclosure, V_{G}(%) may be estimated to be approximately 10 vol %.

For example, in the case of a vacuum insulation panel in which the core material is formed only of glass wool, the flexural modulus of the core material, which includes glass fibers constituting the glass wool and the void space provided in a vacuum state, may be measured to be approximately 136.5 MPa. In this case, since the volume fraction of glass fiber is 10 vol % in the receiving space and the volume fraction of the vacuum space is 90 vol %, the flexural modulus of glass fiber may be calculated by the following Rules of Mixture equation.

136.5=E_{f,G}*0.1+E_{f,s}*0.9

Similarly, by substituting 0 for E_{f,s}, the final result may be that E_{f,G} is approximately 1365 MPa.

In the following, E_{f,v} may be calculated, and the final Vv(%) may be calculated.

For example, in the case of a vacuum insulation panel having a core material formed only by horizontal arrangement and lamination of a plurality of vermiculite sheets P, it may be measured that the density of the core material is 2330 kg/m³, and the flexural modulus is 1655 MPa. In this case, the density of the exfoliated vermiculite sheets P may be 2500 kg/m³, and thus, it may be calculated that the volume fraction of the exfoliated vermiculite sheets P included in the core material is approximately 93.2 vol %. Substituting this into the Rules of Mixture equation using the flexural modulus measured above, it may be expressed as follows.

1655=E_{f,v}*0.932+E_{f,s}*0.062

Therefore, the flexural modulus E_{f,v} of only the vermiculite sheets P may be calculated to be approximately 1775 MPa.

In conclusion, when 1365 is substituted for E_{f,G}, 0.1 (10 vol %) is substituted for V_{G}(%), and 1775 is substituted for E_{f}, ᵥ in the above equation of 300=E_{f,G}*V_{G}(%)+E_{f,s}* Vs(%)+E_{f,v}*Vv(%), it can be seen that in order for the vacuum insulation panel 1 formed of glass wool and vermiculite sheets P to have a flexural modulus (E_{f}) of 300 MPa, the vermiculite sheets P should be included in the receiving space 15 at a volume fraction of approximately 9.2 vol %.

It is understood that the values for the volume by which the above configurations are included in the core material 20 are examples, and may vary depending on the target flexural modulus.

In an example, the vacuum insulation panel 1 may be utilized in the wall space of a refrigerator to insulate the storage compartment of the refrigerator from the external environment. As another insulation for insulating the storage compartment of the refrigerator from the external environment, PU foam has been utilized in the related art. In the case of PU foam, the flexural modulus may be measured to be 11 MPa. This may mean that when the vacuum insulation panel 1 and PU foam are manufactured to have the same amount of deformation by external forces, the thickness of the vacuum insulation panel 1 may be manufactured thinner than the PU foam.

In the following, the thickness of the vacuum insulation panel 1 having the flexural modulus of 300 MPa described above and the related art PU foam will be specifically compared when the vacuum insulation panel 1 and the related art PU foam are deformed by the same external force by the same amount of deformation (δmax).

For the calculation, it may be assumed that the vacuum insulation panel 1 and the PU foam are cantilevers each having a rectangular cross-section. When an external force F is applied to the cantilever, the maximum deformation amount (δmax) of the cantilever may be calculated by the following equation.

δmax=F*L³/(3*E*I)

In the above equation, F may denote the external force F acting on the cantilever, L may denote a length of the cantilever, E may denote the flexural modulus, and I may denote a second moment of area.

The second moment of area of a rectangle may be calculated by the following equation.

I=W*T³/12

In the above equation, W may denote a width of the cross-section, and T may denote a height of the cross-section, which is the thickness. Substituting the above equation for the second moment of area (I) into the equation for the deformation amount of the cantilever, the following equation may be obtained.

δmax=4*F*L³/(E*W*T³)

In the above equation, it may be assumed that the length L and width W of the vacuum insulation panel 1 and the PU foam are the same. When the vacuum insulation panel 1 and the PU foam are deformed by the same maximum deformation amount δmax by the same external force F, 11 MPa may be substituted for the flexural modulus (E) of the PU foam, and 300 MPa may be substituted for the flexural modulus (E) of the vacuum insulation panel 1.

Thus, by summarizing the above equation, it may be calculated that the thickness of the vacuum insulation panel 1 is approximately 0.33T when the thickness of the related art PU foam is T.

In other words, even when the vacuum insulation panel 1 is deformed by the same amount of deformation (δmax) as when the PU foam is utilized, the thickness of the vacuum insulation panel 1 may be 0.33 times the thickness as the PU foam, e.g. approximately one third the thickness, so that the walls of the refrigerator may be made thinner and the size of the storage compartment may be expanded. Therefore, the storage capacity of the refrigerator may be further increased.

In an example, when a PU foam is used in a refrigerator, a thickness of 30 to 50 mm may be required for insulation performance and maintaining the shape of the refrigerator, but when the vacuum insulation panel 1 is used, it may be manufactured with a thickness of 0.33*30 mm (9.9 mm) to 0.33*50 mm (16.5 mm).

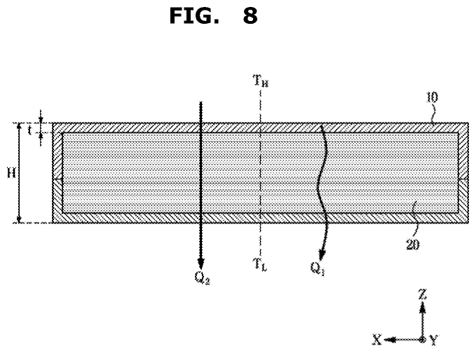

FIG. 8 is a view of a vacuum insulation panel according to one or more embodiments, in which heat is transmitted through the vacuum insulation panel in the form of conduction and radiation.

Referring to FIG. 8, it may be confirmed that heat flows from a high heat source T_{H} to a low heat source T_{L} in the form of radiation Q1 and conduction Q2.

Hereinafter, as heat passes through the vacuum insulation panel 1 in the form of radiation Q1, the thermal radiation transmittance of the vermiculite sheets P of the second core material layer 22 and heat transfer Q1 by radiation will be described.

Depending on the properties of the vermiculite material V, the transmittance by thermal radiation Q1 in an up-and-down direction may be provided at approximately 10% or less. In light of the fact that the thermal radiation Q1 transmittance of the outer shell materials 10 of the related art vacuum insulation panels 1 is also provided to be 10% or less, when the vermiculite sheets P are included in the core material 20, it is possible to exclude the metal or metal oxide material that was included in the outer shell material 10 so as to prevent thermal radiation Q1 in the related art vacuum insulation panels 1.

When metal or metal oxide is included in the outer shell material 10, thermal bridging occurs in the outer shell material 10 through the metal or metal oxide, which causes a decrease in the insulation performance of the vacuum insulation panel 1. Therefore, excluding the metal or metal oxide material from the outer shell material 10 by including the vermiculite sheets P in the core material 20 may prevent thermal bridging, thereby further improving the overall insulation performance of the vacuum insulation panel 1.

Hereinafter, when heat is conducted Q2, for example in the up-and-down direction (+−Z direction), which is a direction from the high heat source T_{H} to the low heat source T_{L}, in the second core material layer 22 of the core material 20, the thermal conductivity of the vermiculite sheets P forming the second core material layer 22 in the up-and-down direction may be calculated. Further, utilizing the description and discussion with reference to FIG. 7, the final thermal conductivity K of the vacuum insulation panel 1 may be calculated for a case in which glass wool is included at 10 vol % and vermiculite sheets P are included at 9.2 vol %.

The heat Q2 conducted by the vacuum insulation panel 1 may flow through the outer shell material 10 and the core material 20.

For example, in the case of a vacuum insulation panel in which the core material is formed only of glass wool, the thermal conductivity of the vacuum insulation panel may be measured to be 2.27 mW/mK by a flat plate heat flow meter method using an insulation thermal conductivity measuring device (e.g., Heat Flow Meter). At this time, the thermal conductivity of the outer shell material may be assumed to be approximately 0.5 mW/mK in the case of Al(Aluminum) is deposited on the outer shell material. When the core material is formed from glass wool alone, the volume fraction of glass fiber of 10 vol % previously calculated may be used. In conclusion, the thermal conductivity of glass fiber may be calculated using the following Rules of Mixture equation.

2.27=K_{G}*0.1+0.5

That is, it can be seen that the thermal conductivity K_{G} of glass fiber alone is 17.7 mW/mK.

For example, in the case of a vacuum insulation panel having a core material formed only by horizontal arrangement and lamination of a plurality of vermiculite sheets P, the thermal conductivity of the vacuum insulation panel may be measured to be 4.85 mW/mK through the heat flow meter method using an insulation thermal conductivity measuring device. Even in this case, the thermal conductivity of the outer shell material may be assumed to be approximately 0.5 mW/mK when Al is deposited on the outer shell material.

When the core material is formed only of a plurality of vermiculite sheets P, the volume fraction of 9.2 vol % occupied by the vermiculite sheets P previously calculated may be utilized. In conclusion, the thermal conductivity Kv of the vermiculite sheets P alone may be calculated using the following Rules of Mixture equation.

4.85=Kᵥ*0.092+0.5

That is, it can be seen that the thermal conductivity Kᵥ of the vermiculite sheets P alone is approximately 4.66 mW/mK.

For example, the thermal conductivity K of the vacuum insulation panel 1 in which the core material 20 includes 10 vol% of the glass fibers 211 and 9.2 vol % of the vermiculite sheets P may be calculated as follows. In addition, when the vermiculite sheets P are included in the core material 20, metal or metal oxides may be excluded from the outer shell material 10, so that the thermal conductivity of 0.5 mW/mK in the outer shell material 10 may not be considered because the outer shell material 10 does not include a layer on which Al is deposited.

K=17.7*0.1+4.66*0.092

In conclusion, utilizing the description and discussion with reference to FIG. 7, the final thermal conductivity K of the vacuum insulation panel 1 when the glass fibers 211 are included at 10 vol % and the vermiculite sheets P are included at 9.2 vol %, may be calculated to be approximately 2.2 mW/mK. This may mean that the core material 20 has a lower thermal conductivity compared to an insulation material formed by glass wool alone or PU foam, thereby providing the vacuum insulation panel 1 with high insulation performance.

The vacuum insulation panel 1 according to one or more embodiments may include the outer shell material 10 including the receiving space 15 therein, and the core material 20 disposed in the receiving space 15. The core material 20 may include the first core material layer 21 including the support 211 extending in a longitudinal direction of the outer shell material 10 and made of a porous material, and the second core material layer 22 in contact with the first core material layer 21, extending in the longitudinal direction of the outer shell material 10, and formed by the plurality of materials P arranged parallel to a direction in which the outer shell material 10 extends and laminated in an outward direction.

The plurality of materials P may include the vermiculite sheet P exfoliated from vermiculite.

The first core material layer 21 may include the plurality of first core material layers 21a and 21b, and the second core material layer 22 may include the plurality of second core material layers 22a and 22b, and the plurality of first core material layers 21a and 21b and the plurality of second core material layers 22a and 22b may be laminated alternately one by one in the outward direction.

The flexural modulus of the vacuum insulation panel 1 may be provided to be 300 MPa or more.

The support 211 may include glass fibers constituting glass wool, and a volume fraction of the support 211 in the receiving space 15 may be provided to be 10 vol % or more.

The volume fraction of the plurality of materials P in the receiving space 15 may be provided to be 9.2 vol % or more.

The thickness of the vacuum insulation panel 1 in the outward direction may be provided to be 0.33*30 mm (9.9 mm) or more and 0.33*50 mm (16.5 mm) or less.

The second core material layer 22 may include the binder B configured to bond the plurality of materials P to each other, and the binder B may include any one of polyvinylidene fluoride (PVDF) or polytetrafluoroethylene (PTFE).

The outer shell material 10 may include the first outer shell layer 14 in contact with the core material 20, and the second outer shell layer 11 disposed spaced apart from the first outer shell layer 14 and forming an outer surface of the vacuum insulation panel 1.

The first outer shell layer 14 may include linear low density polyethylene (LLDPE), and the second outer shell layer 11 may include nylon.

The outer shell material 10 may be configured not to include metal or metal oxide.

The receiving space 15 may be provided in a vacuum state.

The vacuum insulation panel 1 according to one or more embodiments may include the outer shell material 10 forming the receiving space 15 therein and including a plurality of outer shell layers, and the core material 20 disposed in the receiving space 15. The core material 20 may include the first core material layer 21 including the support 211 extending in a longitudinal direction of the outer shell material 10 and made of a glass fiber material constituting glass wool, and the second core material layer 22 in contact with the first core material layer 21 and formed to extend in the longitudinal direction of the outer shell material 10. The second core material layer 22 may be formed by the vermiculite sheets P exfoliated from vermiculite and arranged parallel to a direction in which the outer shell material 10 extends and laminated in an outward direction.

The first core material layer 21 may be provided in a vacuum state, and the second core material layer 22 may be provided not to include an air layer, so that the receiving space 15 may maintain in a vacuum.

The first core material layer 21 may include the plurality of first core material layers 21, and the second core material layer 22 may include the plurality of second core material layers 22, wherein the plurality of first core material layers 21 and the plurality of second core material layers 22 may be laminated alternately one by one in the outward direction.

The volume fraction of the support 211 in the receiving space 15 may be provided to be 10 vol % or more, and the volume fraction of the vermiculite sheets P in the receiving space 15 may be provided to be 9.2 vol % or more, so that the flexural modulus of the vacuum insulation panel 1 may be formed to satisfy 300 MPa or more.

The second core material layer 22 may further include the binder B configured to bond the vermiculite sheets P to each other, and the binder B may include any one of PVDF or PTFE.

The outer shell material 10 may include the first outer shell layer 14 in contact with the core material 20 and including LLDPE, and the second outer shell layer 11 disposed spaced apart from the first outer shell layer 14 and forming an outer surface of the vacuum insulation panel 1 and comprising a nylon material.

The vacuum insulation panel 1 according to one or more embodiments may include the outer shell material 10 forming the receiving space 15 therein, which is provided in a vacuum, and including a plurality of outer shell layers, and the core material 20 disposed in the receiving space 15. The core material 20 may include the first core material layer 21 including the support 211 extending in a longitudinal direction of the outer shell material 10, the first core material layer 21 being formed such that a volume fraction of the support 211 in the receiving space 15 is 10 vol % or more. The core material 20 may include the second core material layer 22 including the plurality of materials P in contact with the first core material layer 21, the second core material layer 22 being formed such that a volume fraction of the plurality of materials P in the receiving space 15 is 9.2 vol % or more. The plurality of materials P may be provided to be arranged parallel to a direction in which the outer shell material 10 extends and laminated in an outward direction.

The plurality of materials P may include vermiculite sheets P exfoliated from vermiculite, and the flexural modulus of the vacuum insulation panel 1 may be formed to satisfy 300 MPa or more.

According to one or more embodiments of the present disclosure, the rigidity of the vacuum insulation panel may be improved as the vermiculite sheets are arranged in the core material.

According to one or more embodiments of the present disclosure, the vacuum state of the core material may be stably maintained as the vermiculite sheets are provided in a plate shape and do not include an air layer, thereby further improving the insulating life.

According to one or more embodiments of the present disclosure, heat transfer by thermal radiation in the vacuum insulation panel may be prevented by the vermiculite sheets, and thermal bridging phenomena may be prevented by not using metal materials for the outer shell material.

According to one or more embodiments of the present disclosure, it is possible to insulate a refrigerator with the vacuum insulation panel having a thinner thickness than related art insulation, thereby securing more storage space in the refrigerator.

The effects to be obtained from the present disclosure are not limited to the effects mentioned above, and other unmentioned effects can be clearly understood by those of ordinary skill in the art to which the present disclosure pertains from the description below.

While the present disclosure has been particularly described with reference to example embodiments, it should be understood by those of skilled in the art that various changes in form and details may be made without departing from the spirit and scope of the present disclosure.

What is claimed:

1. A vacuum insulation panel comprising:
an outer shell material defining a receiving space therein; and
a core material in the receiving space;
wherein the core material comprises:
a first core material layer comprising a support extending in a longitudinal direction of the outer shell material, the support comprising a porous material; and
a second core material layer in contact with the first core material layer, extending in the longitudinal direction of the outer shell material, the second core material layer comprising a plurality of laminated materials arranged parallel to a direction in which the outer shell material extends.

2. The vacuum insulation panel of claim 1, wherein each of the plurality of laminated materials comprises a vermiculite sheet exfoliated from vermiculite.

3. The vacuum insulation panel of claim 1, wherein the first core material layer comprises a plurality of first core material layers,
wherein the second core material layer comprises a plurality of second core material layers, and
wherein the plurality of first core material layers and the plurality of second core material layers are alternately laminated.

4. The vacuum insulation panel of claim 2, wherein a flexural modulus of the vacuum insulation panel is at least 300 MPa.

5. The vacuum insulation panel of claim 4, wherein the support comprises glass fibers constituting glass wool, and
wherein a volume fraction of the support relative to the receiving space is at least 10 vol %.

6. The vacuum insulation panel of claim 5, wherein a volume fraction of the plurality of laminated materials relative to the receiving space is at least 9.2 vol %.

7. The vacuum insulation panel of claim 4, wherein a thickness of the vacuum insulation panel is in a range of 9.9 mm to 16.5 mm, inclusive.

8. The vacuum insulation panel of claim 1, wherein the second core material layer comprises a binder configured to bond the plurality of laminated materials to each other, and
wherein the binder comprises any one of polyvinylidene fluoride (PVDF) or polytetrafluoroethylene (PTFE).

9. The vacuum insulation panel of claim 1, wherein the outer shell material comprises:
a first outer shell layer in contact with the core material; and
a second outer shell layer spaced apart from the first outer shell layer and forming an outer surface of the vacuum insulation panel.

10. The vacuum insulation panel of claim 9, wherein the first outer shell layer comprises linear low density polyethylene (LLDPE), and
wherein the second outer shell layer comprises nylon.

11. The vacuum insulation panel of claim 1, wherein the outer shell material does not include a metal or a metal oxide.

12. The vacuum insulation panel of claim 1, wherein the receiving space is in a vacuum state.

13. A vacuum insulation panel comprising:
an outer shell material defining a receiving space therein, the outer shell comprising a plurality of outer shell layers; and
a core material in the receiving space,
wherein the core material comprises:
a first core material layer comprising a support extending in a longitudinal direction of the outer shell material, wherein the support comprises glass fibers constituting glass wool; and
a second core material layer in contact with the first core material layer and extending in the longitudinal direction of the outer shell material, the second core material layer comprising a plurality of laminated materials arranged parallel to a direction in which the outer shell material extends, each of the plurality of laminated materials comprising a vermiculite sheet exfoliated from vermiculite.

14. The vacuum insulation panel of claim 13, wherein the first core material layer is in a vacuum state, and the second core material layer does not include an air layer, such that the receiving space maintains a vacuum.

15. The vacuum insulation panel of claim 13, wherein the first core material layer comprises a plurality of first core material layers, and the second core material layer comprises a plurality of second core material layers, and
wherein the plurality of first core material layers and the plurality of second core material layers are alternately laminated.

16. The vacuum insulation panel of claim 13, wherein a volume fraction of the support relative to the receiving space is at least 10 vol % or more, and
wherein a volume fraction of the plurality of laminated materials relative to the receiving space is at least 9.2 vol %.

17. The vacuum insulation panel of claim 13, wherein a flexural modulus of the vacuum insulation panel is at least 300 MPa.

18. The vacuum insulation panel of claim 13, wherein the second core material layer comprises a binder configured to bond each of the plurality of laminated materials to each other, and wherein the binder comprises any one of polyvinylidene fluoride (PVDF) or polytetrafluoroethylene (PTFE).

19. The vacuum insulation panel of claim 13, wherein the outer shell material comprises:
a first outer shell layer in contact with the core material, the first outer shell layer comprising linear low density polyethylene (LLDPE), and
a second outer shell layer spaced apart from the first outer shell layer and forming an outer surface of the vacuum insulation panel, the second outer shell layer comprising a nylon material.

20. A vacuum insulation panel comprising:
an outer shell material defining a receiving space provided in a vacuum state, the outer shell material comprising a plurality of outer shell layers; and
a core material in the receiving space,
wherein the core material comprises:
a first core material layer comprising a support extending in a longitudinal direction of the outer shell material, wherein a volume fraction of the support relative to the receiving space is at least 10 vol %; and
a second core material layer in contact with the first core material layer and extending in the longitudinal direction of the outer shell material, the second core material layer comprising a plurality of laminated materials arranged parallel to a direction in which the outer shell material extends, each of the plurality of laminated materials comprising a vermiculite sheet exfoliated from vermiculite, and
wherein a volume fraction of the plurality of laminated materials relative to the receiving space is at least 9.2 vol %.
